(19) United States
(12) Patent Application Publication
(10) Pub. No.: US 2013/0341926 A1
(43) Pub. Date: Dec. 26, 2013

(54) Wavewheel

(71) Applicant: John Edward Fay, Wilmette, IL (US)

(72) Inventor: John Edward Fay, Wilmette, IL (US)

(21) Appl. No.: 13/507,399

(22) Filed: Jun. 25, 2012

(51) Int. Cl. F03B 13/18

(52) U.S. Cl. 290/53

(57) ABSTRACT

Using creativity, prior art (in general) and the prior art of generating electricity from water flow (in particular) this invention creates machinery to generate electricity from water waves.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention pertains to the field of endeavor generally known as “ocean wave energy”, though many lake waves and similar water waves would also be applicable. Specifically, the invention is a machine that can generate electricity from the movement of water waves.

A general knowledge of how electricity was generated by early American waterwheels, and how that process was adapted to generate electricity at America's modern hydro-electric plants (located at some of America's most prominent hydro-electric dams) is all that's necessary, for a person of ordinary skill in the art, to understand the invention.

The only real “problem” the invention solves is the current technology's failure to creatively, simply, and effectively apply the prior art to the problem of generating electricity from water waves (that perpetually go up and down) instead of from water flow (that perpetually goes in the same direction—like a river's stream).

### BRIEF SUMMARY OF THE INVENTION

In 1831, Michael Faraday discovered that an electric current is created in a conductor (like a copper wire) if said wire is moved near a magnet, or, if said magnet is moved near the wire.

That simple discovery is the principle upon which all of our modern dynamo-generators (hereinafter, simply, “generators”) are based, and is the source of essentially all our electricity.

It has enabled mankind to generate tremendous energy from waterwheels: first, by vertical wooden waterwheels turned by the natural flow of our rivers, and then, many years later, by horizontal waterwheels (also known as “turbines”) turned by the man-controlled flow of rivers at our modern hydro-electric dams.

This electrical energy, in turn, has enabled the long series of inventions that followed it—electrical machines and appliances of all kinds, like the phonograph and the movie projector, of Thomas Edison, all the way up to the iPod and iPad, of Apple Computer—which has made our modern standard of living possible.

But, because the electricity we could generate from water flows (in our rivers) was once sufficient (when coupled with oil and gas, etc,) to meet our needs, the question of how to generate even more energy, from water waves, seemed pointless. As a result, it was there that the giants, in the field of electrical generation, largely stopped their efforts.

Today, however, mankind's appetite for clean, renewable energy is soaring far beyond that point (along with our need to attain energy independence, and stop sending billions of our dollars, each year, to enemies of this country, just because we—with the immense natural resources of United States—haven't yet had the wits to harness the rest of our own energy).

The earth's oceans, alone, cover more than 139 million square miles of surface area (which is over forty-six times the size of the continental United States!) and we have vast access to these waters from our own shores.

Some creative soul needs to pick up, again, where the founding fathers of this art left off, and convert these vast resources into electricity—and that's what this invention is all about. There have been numerous attempts to accomplish this, over the years, but none, so far, has truly proven satisfactory.

This invention doesn't involve any new scientific discoveries, per se. Rather, it simply uses creativity and prior art to extend our generating capacity into oceans, lakes, and similar bodies of water where waves are prevalent.

### BRIEF DESCRIPTION OF THE SEVERAL VIEWS OF THE DRAWING

The first four embodiments of the invention pertain to relatively mild-weather applications, and are numbered as follows: Embodiment 1, Embodiment 2, Embodiment 3, and Embodiment 4.

The other four embodiments pertain to relatively severe-weather applications, and are numbered as follows: Embodiment 5, Embodiment 6, Embodiment 7, and Embodiment 8.

The invention is presented this way because each embodiment is important and distinct enough (in its own right) to require mention, and, yet, simply a particular species of the same genus.

For these reasons, then, there are eight drawings presented in this application, as follows:

FIG. 1 (which represents Embodiment 1);

FIG. 2 (which represents Embodiment 2);

FIG. 3 (which represents Embodiment 3);

FIG. 4 (which represents Embodiment 4);

FIG. 5 (which represents Embodiment 5);

FIG. 6 (which represents Embodiment 6);

FIG. 7 (which represents Embodiment 7);

FIG. 8 (which represents Embodiment 8).

Each drawing is presented in portrait orientation, with the top of the drawing at the top, the bottom of the drawing at the bottom, the left side of the drawing at the left, and the right side of the drawing at the right.

Further, each drawing should be looked at as though the viewer were standing on level ground, or sitting on a level chair, and looking straight ahead at it, more or less, as you would look at something in front of you in the real world.

### DETAILED DESCRIPTION OF THE INVENTION

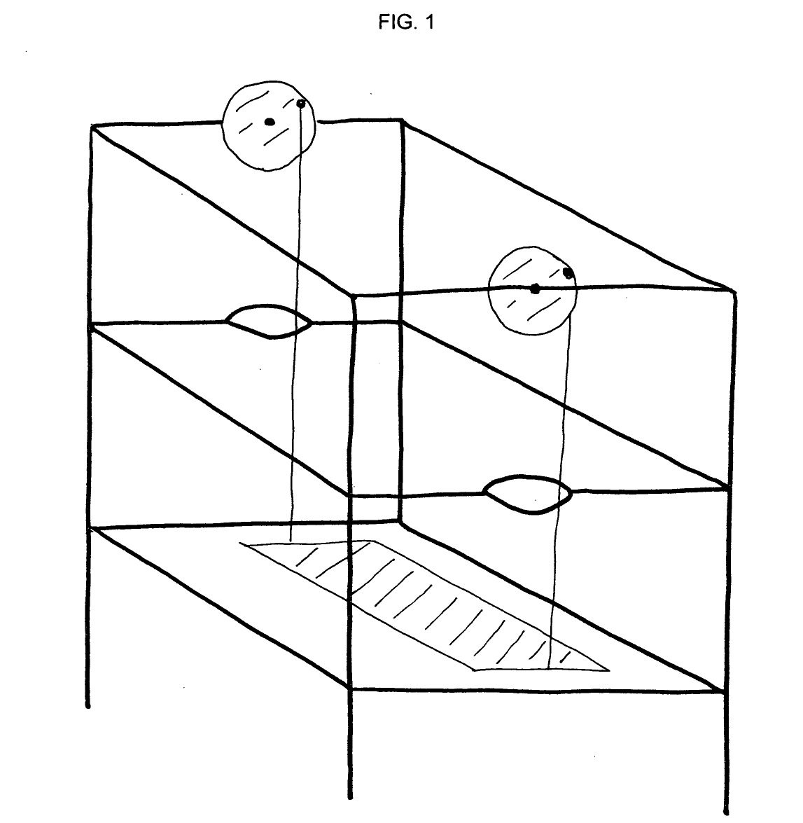

Embodiment 1 of the invention is represented by FIG. 1. A detailed description of both Embodiment 1 and FIG. 1 are set out below.

The general frame of the machine called Embodiment 1, as shown in FIG. 1, should be made of a strong, corrosion-resistant material, and a corrosion-resistant metal would be one possibility. In any event, it is a simple frame, which a person of ordinary skill in such art could construct.

Attached to the frame, at the top, are two circular items, each of which represents an electric generator that a person, of ordinary skill in the art, might make to generate electricity from the spinning of a vertical waterwheel, or a turbine (or, the somewhat similar devices used to generate electricity from the spinning of our modern-day windmills). Basically, it would consist of a conductor that was positioned to spin around a magnet, or, a magnet that was positioned to spin around a conductor, as per Michael Faraday's famous (and above-referenced) discovery.

The inventor calls each of these circular generators a “wavewheel”, and the invention's name (The Wavewheel) is derived from that term. It should be noted that the “wavewheels” themselves have been placed above the waterline, where they would remain largely out of contact with the water, and, thus, largely unexposed to the corrosive effects of the water itself. This is just one of the many advantages of this invention, which many recent inventions don't share.

Each of the two generators, noted above, is connected to the frame of the machine, at each generator's own center, so each generator can spin properly.

Further, each generator is connected to a more-or-less vertical beam, at an off-center point on the generator itself, much like a person of ordinary skill, in the art of railroad-engine design, might mimic the design of an old-time railroad-engine wheel, by connecting it (with a beam, in an off-center location) to another wheel.

Each of the two beams, which is thus-attached (at its upper end) to a generator, is also attached (at its lower end) to the end of the floating board which is nearest to it.

The floating board in FIG. 1 is a modified surf-board, of sorts, and acts like one of the “blades” of a waterwheel, in that it receives the water's pressure (here, in the form of a water wave) and is moved by it, and that movement, then, turns the two generators (“wavewheels”) it is connected to (via the two beams) which generates electricity.

The way the floating board is connected to the beams (by a person of ordinary skill in such art) also gives the board the ability to pivot a reasonable amount (from its standard, parallel-to-the-ground position) in either direction, if/as the machine's operator may so desire, be it by a spring-like feature, or otherwise.

The board is also corrosion-resistant, and sufficient enough, in its size and buoyancy, to float on the water that the machine is placed into, despite the relatively modest amount of weight exerted upon said board by the two beams and two generators connected to it.

A collar, of sorts, is also included on each of two sides of the frame, with one around each of the two beams in question (as shown on FIG. 1) to prevent the beams and the floating board from drifting too far out of position. The collar for each beam would be placed at a desired point between that beam's two ends, and would be large enough to allow the beam in question the freedom of motion it needs to operate successfully.

The beams themselves could be embedded with springs within them (rather like pogo sticks) and set at varying levels of resistance, in order to match the conditions then at hand, to allow the beams to expand and contract their length (and, thus, soften the motion of the waves upon them and the machine) if/as the operator so desired.

For simplicity's sake, FIG. 1 only shows a frame with one board. In truth, however, a frame might be built to house many boards, in many different rows (perhaps ten rows, with ten boards per row, for example) all to be determined, most likely, by which configuration would yield the best results for the conditions then at hand.

Regardless of how many boards were in the frame, the frame would be set into the water, and either held up by frame-legs, or buoys, or both (or, in some cases, perhaps—where the number of boards was large enough—by the machine's own buoyancy).

When a wave came to a board, the rise of the wave would raise the board in question upward (like a piston might be raised up, in a combustion engine) and that would drive the beams at each end of the board upward, as well. This upward movement of the beams, then, would turn the generators (although, in this particular embodiment of the invention, not necessarily for a full turn) and electricity would be generated.

(It should be noted, here, that some waves actually tend to move in a circular motion, despite common beliefs to the contrary.)

To consider a specific example, let's suppose a wave raised the board in FIG. 1 enough to move the two generators for a half-turn, in a counter-clockwise direction.

When the wave in question fell back down, the gravitational weight of the board (and the two beams and two generators connected to it—if the machine was set up properly) would push the board back down, which, in turn, would make the two generators move again (either to complete the counter-clockwise half-turn they already started, on the wave's up-swing, or, to fall back down the other way, in a clockwise direction). Either way, another half-turn's worth of electricity would be generated, in both of the generators, by the downward portion of the wave's cycle.

Using prior art, a person of ordinary skill could convert any alternating current thus-generated into direct current, and/or, convert any direct current thus-generated into alternating current, as desired.

Further, a person of ordinary skill could likewise rely on the prior art to manage the fact that some of the boards would be generating electricity on their “up-swings” (or, by producing a counter-clockwise motion, for example) while other boards were generating electricity on their “downswings” (or, by producing a clockwise motion, for example) by referring to how operators of modern-day wind farms, for example, manage the fact that some windmills might be generating electricity from “clockwise” spins while other windmills might be generating electricity from “counter-clockwise” spins.

Further still, a person of ordinary skill could rely upon the prior art to manage the fact that not every generator would be experiencing equal wave conditions at the same time (and, thus, would not be generating an equal amount of electrical output at the same time) by referring to how operators of modern-day wind farms, for example, manage when not every windmill might be experiencing equal wind conditions at the same time (and, thus, is not generating an equal amount of electrical output at the same time).

Thus, a person of ordinary skill in the art should be able to merge the diversity of all the currents produced, by the various generators, into one, or more, useful stream(s) of electricity, as effectively as the operators of modern-day wind farms, and other operations, can do on their wind farms and other operations.

A “zoning plan”, of sorts, could be established, for the oceans and lakes in question, and be based upon the pre-existing knowledge of the wave patterns, wind patterns, sea depth, sea-wildlife habitats, and other features of the waters in question (which entities like the U.S. Navy, for example, may already be in possession of) in order to establish the best places for shipping lanes, open water spaces, sea-wildlife preserves, off-shore wind energy farms, and wave energy farms, etc., so the waters would be used in the optimal ways possible, for the benefit to everyone involved (including the public).

Further, machines comprised of many floating boards (and their corresponding parts) could (if the operator so desired) be built with some sort of water skis, or toboggan sled features on them, and thus moved (by a tug boat, or some such thing) from one location to another, based upon where the waves were forecast to be, at any given time.

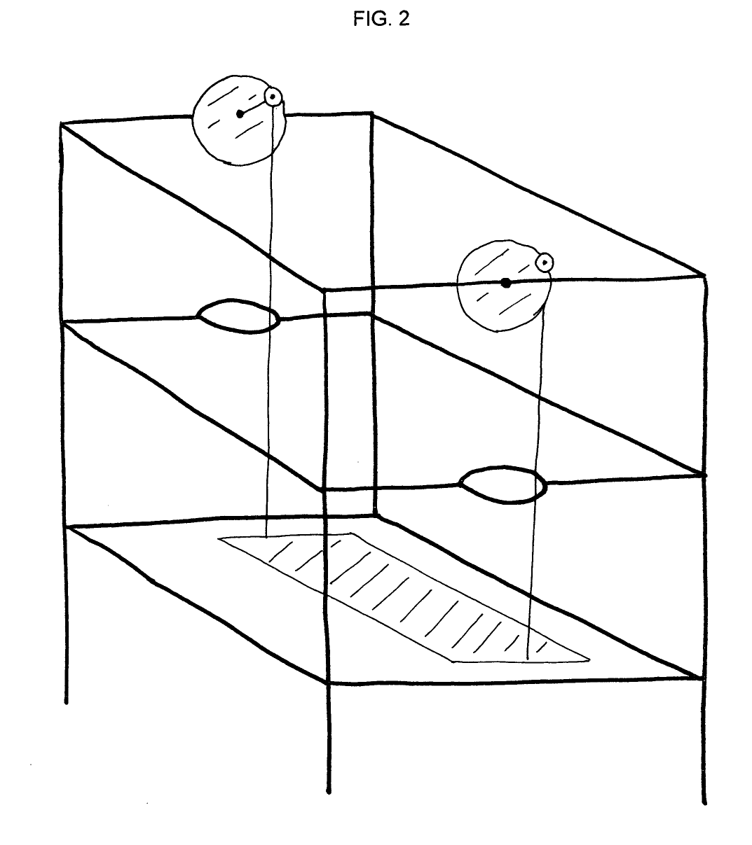

Embodiment 2 of the invention is shown in FIG. 2, and it is similar, in many ways, to Embodiment 1, but opens up many other possibilities for itself (and, perhaps more importantly, for Embodiment 6, discussed later) that are profoundly different, and potentially much superior.

Specifically, if you split Embodiment 2 (in your mind) into a left half and a right half, you see that each half is very much like an upside-down gasoline engine: the floating board is like the piston, the beam is like the connecting rod, and the way the upper end of the beam is connected to the generator (a way that differs somewhat from the connection in Embodiment 1) makes that connection like the crankshaft of said gasoline engine (except that, in this case, the crankshaft turns the generator, to generate electricity).

This realization, then, brings into play all the other aspects of gasoline engines that the prior art could suggest. Although this is examined primarily in the description of Embodiment 6, it could, nonetheless, be applied to Embodiment 2, as well.

For example, the area surrounding the floating board could be sealed up, to form a rectangular piston chamber, of sorts. Further, intake and outtake valves (like those on a gasoline engine) could then be included, as well, to help regulate the amount of water that gets in, and out, of said chamber (like such valves regulate how much air and gas get in, and out, of a piston chamber).

As a further example, two flywheels could be included (one for each of the two, above-named “crankshafts” in Embodiment 2) to make steadier the rate at which said “crankshafts” turn (like a flywheel does for the crankshaft of a gasoline engine).

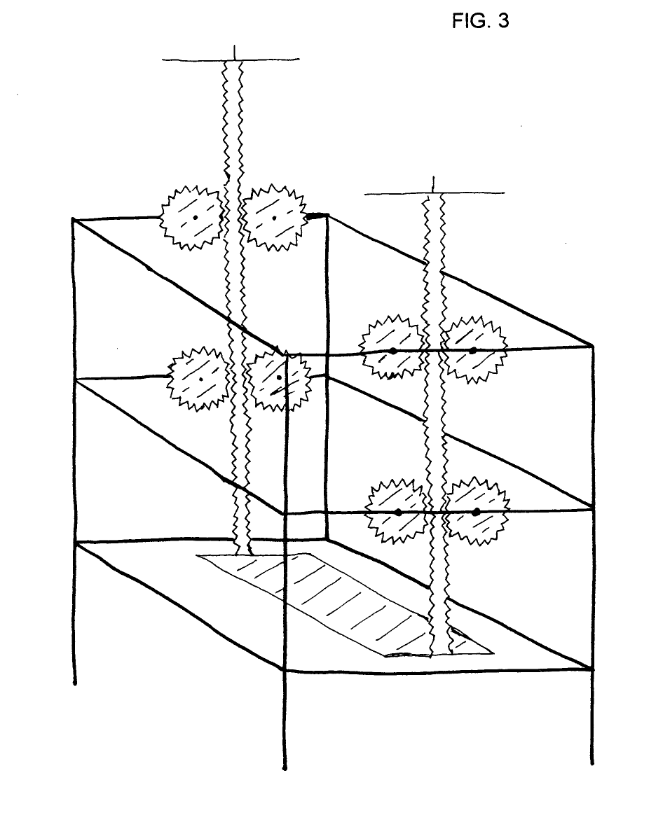

Embodiment 3 of the invention is represented by FIG. 3, and differs from Embodiment 1 in the following ways.

In Embodiment 3, there are twice as many generators at the top (four, instead of two) as there are in Embodiment 1, because the generators are placed in pairs (one generator on the left side of each beam, and one generator on the right side of each beam) rather than in isolation (only one generator per beam, as is the case in Embodiment 1 and Embodiment 2).

Further, each generator (“wavewheel”) has teeth cut into the outer edge of its circular shape, so that when Embodiment 3 is assembled, the generator placed on the left side of a beam, and the generator placed on the right side of that beam, also act as gears (and thus become “generator-gears”, one might say—the Embodiment 3 variety of “wavewheels”) which mesh with the teeth cut into the left side and the right side of the beam placed between them.

Also, at an optimal point on each beam, somewhere between the top (where the pair of “generator-gears” spoken of, above, are placed) and the bottom (where said beam is connected to the nearest edge of the floating board, as per the arrangement in Embodiment 1) there is a second pair of gears.

These lower pairs of gears are herein called “stability gears”, because they are used (instead of the “collars”, used in Embodiment 1 and Embodiment 2) to stabilize the movement of the beams, as the beams are pushed up and down (by the force of the waves, on the upswing, and, then, by the force of gravity, on the downswing).

(These pairs of “stability gears” could also be in the form of “generator-gears”, themselves, and thus be made capable of generating electricity, like the “generator-gears” above them, if so desired.)

Like the “generator-gears” above them, each “stability gear” also has teeth cut into the outer edge of its circular shape, so that when two of them are placed, as a pair, on both sides of a beam (one on the left side of the beam, and the other on the right side of a beam) they likewise mesh with the teeth cut into the left side and right side of the beam in question, and thus (when the machine is properly assembled) stabilize the upward and downward movements of that beam.

(Also note: If there are mechanisms in the beams of Embodiment 3, at all, which will allow those beams to expand and contract like a pogo stick—as could be the case with the beams in Embodiment 1 and Embodiment 2—they will probably be used to a much lesser extent than they might be used with Embodiments 1 and 2.)

(Further note: The “stability gears” might possibly be affixed to the machine's frame, by a person of ordinary skill in such art, in a way that allows them to slide somewhat to the left and/or right—either in a series of fixed positions, or, by a pogo-stick type of spring-tension approach—to further accommodate the machine to particular conditions. It would also be possible to eliminate the “stability gears” altogether, and allow the beams to sway even more freely amidst the to-and-fro motion of the waves.)

There would also be a “stopper” at the top of each beam, to prevent the beam from falling through the two “generator-gears” it is meshed with, in the event that an unusually large wave brought with it an unusually low downswing, on its down cycle. The “stopper” could just be a length of material, which is wide enough and strong enough to prevent the beam from falling through the “generator-gears”, while also being soft enough on its outsize (perhaps by covering it with something like hard rubber) so as not to hurt said “generator-gears” if it came slamming down on them.

A person of ordinary skill in such art could decide upon a set of specifics to be chosen for this purpose (and, indeed, for a soft bumper to be affixed to each end of each floating board, as well, to cushion the shock an unusually high wave might likewise bring, from the other direction, by slamming the board upward, into the “stability gears”, but a machine that was wisely set up should not encounter the need of such “stoppers” or “bumpers” to an excessive degree, if at all.

Additionally, each “stopper” (at the top of the machine) could have a vertical bar affixed to it, onto which weights could be stacked, if the operator determined that such weights might help eliminate any vibrations that impeded the smooth rise and fall of the beams, and/or would otherwise help the machine to function as desired.

When a wave came to a floating board, in Embodiment 3, the rise of the wave would raise the board in question upward (like a piston might be raised up, in a combustion engine) and that would drive the two beams connected to that board (one beam at each end of the board) upward, as well. This upward movement of the two beams, then, would turn the pair of “generator-gears” connected to each beam, somewhat like the flow of a river would turn a waterwheel, and electricity would be generated at all four “generator-gears” (both pairs of “generator-gears”) in question.

To consider a specific example, let's suppose a wave raised the board in FIG. 3 enough to move the two pairs of “generator-gears” for numerous turns each.

When the wave in question fell back down, the gravitational weight of the board (and the beams connected to it—if the machine was set up properly) would push the board back down, which, in turn, would make the two pairs of “generator-gears” in question spin an addition number of times, thus generating additional electricity from the downward portion of the wave's cycle.

The size of the gears in use might not always be the same, if a different sized gear was determined to better suit a different objective (much like the operator of a car might not always choose to drive in any one particular gear).

Thus, an operator might want to incorporate the prior art of “reducing gears” and/or “multiplying gears” from automobile cars, for example, so they became features on Embodiment 3 of this invention. The gears could be changed manually (or, perhaps, automatically, if an operator of ordinary skill in such matters, for example, chose to add an automatic transmission arrangement from the prior art).

In such a case, the operator of the machine might (like the operator of a car) occasionally change the gears because, when a small gear turns a large one, the large gear moves at lower speeds, but with greater pulling power, and, when a large gear turns a small one, the small one yields higher speeds but less pulling power (all of which might give an operator of this machine, who employs such techniques, greater flexibility in managing the waves encountered and in generating electricity from them).

Although FIG. 3 only shows one board, a machine might be built to hold multiple rows of multiple boards (as was the case with Embodiments 1 and 2).

As noted in regard to Embodiment 1, a person of ordinary skill in the art should be able to merge (and otherwise manage, and/or convert) all the diversities of currents that might be produced, by the various “generator-gears”, into one, or more, useful stream(s) of electricity, as effectively as the operators of modern-day wind farms, and other operations, can do.

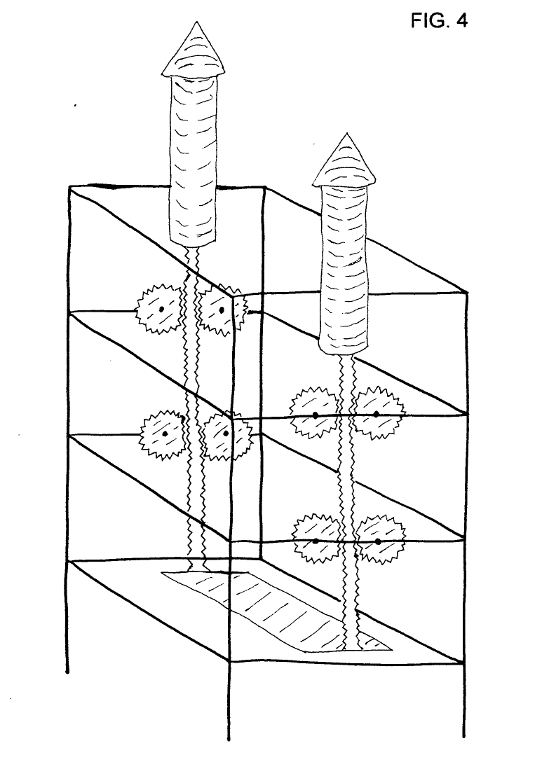

Embodiment 4 of the invention is shown in FIG. 4, and is the same as Embodiment 3, except in the following ways.

In most cases, the “generator-gears” of Embodiment 3 would simply be “gears” in Embodiment 4, with their ability to generate electricity having been removed (although they could be left intact, if an operator really wanted to do that.)

Instead of generating the electricity as was done in Embodiment 3, Embodiment 4 has a “sleeve”, of sorts, attached to the top of the frame, directly over each beam, and positioned so each beam will rise into its respective sleeve when the waves do, in fact, make each beam rise.

Each sleeve would be of a large enough diameter to adequately accept its respective beam, yet of as small a diameter as reasonably possible (to maximize, or, at least, accomplish the desired effect, as set out below).

Further, if the beams in Embodiment 4 were allowed the ability to slant from their vertical position (like the beams in Embodiment 3 might be allowed to do, as set out in the description of Embodiment 3, above) then, the sleeves in Embodiment 4 would also be allowed to correspondingly slant, as a person of ordinary skill in such arts could accomplish, so said sleeves could still accept their respective beams.

The sleeves would also be long enough to accept the furthest rise the beams might accomplish, and be made of a weather-resistant material (perhaps somewhat like a hollow metal fencepost) according to what a person of ordinary skill in the art would deem most appropriate. Additionally, each sleeve might also have a weather-resistant cap (perhaps somewhat like a rounded, metal fencepost cap) according to what a person of ordinary skill in the art would deem most appropriate.

As mentioned far above, Michael Faraday famously discovered, in 1831, that an electric current is created in a conductor (like a copper wire) if said wire is moved near a magnet, or, if said magnet is moved near the wire.

For that reason, then, each of the sleeves in Embodiment 4 would contain magnets within them (in a configuration that a person of ordinary skill in the art would deem most suited to the application at hand) and the upper portions of each beam (which are likely to rise high enough to go into their respective sleeves) would contain copper wire (or other conductors, or be, themselves, composed of some such thing[s]—also in a configuration that a person of ordinary skill in the art would deem most suited to the application at hand).

Then, when a beam was pushed upward by a wave, the conductor at the upper portion of that beam would be pushed into the magnetic field of its respective sleeve, and said motion of the conductor (at the upper portion of the beam) in the near proximity of the magnet (in the sleeve) would generate electricity.

The desired effect (to generate electricity) could also be accomplished if the positions of the conductor and the magnet were reversed, such that the magnets were at the upper end of each beam, and the conductors were inside each sleeve.

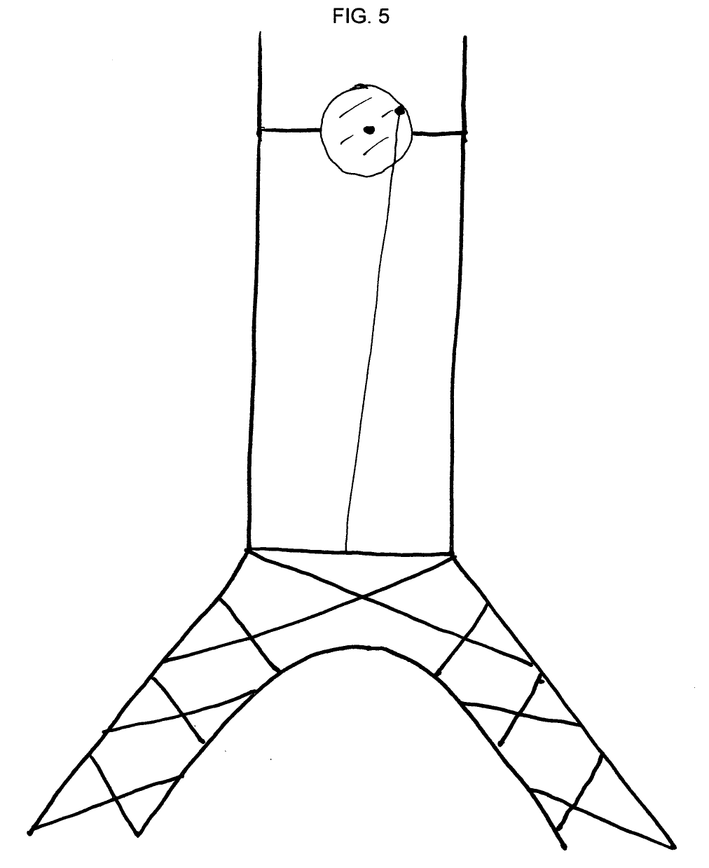

Embodiment 5 is shown in FIG. 5, and is a severe-weather version of Embodiment 1.

Embodiment 5 is the same as Embodiment 1, except as follows.

Rather than be assembled on the frame used for Embodiment 1, the floating board would be placed in a different frame, which would somewhat resemble an oil derrick (but, would even more closely resemble the Eiffel Tower, and, therefore, is simply referred to, hereinafter, as the “tower”).

There would be two distinct sections of the tower. First, its base would be somewhat (or totally) underwater, and would angle out ever more widely as you approached its bottom (like the Eiffel Tower does). This would serve to give the tower added stability, and help it endure the severe motions that might be applied to such a structure, when it's standing in deep water.

Further, since the base (and, possibly, the entire tower) would only be composed of the beams absolutely necessary for its structural integrity, a lot of the water around it could still pass through its sides, and thus minimize the potential water-pressures against it.

Above the base would be the second section of the tower, which the base would gracefully merge into. That second section is hereinafter called the “elevator shaft”, because it would consist of a tall area that extended straight up, like an elevator shaft does, and serve the same kind of purpose that an elevator shaft serves.

The tower would be constructed with corrosion-resistant materials (possibly corrosion-resistant metals) that had the appropriate degree of strength and flexibility, accordingly to what a person of ordinary skill in such arts would deem most appropriate.

The board from Embodiment 1 would be modified into a rather large ship, of sorts, and would essentially become the “elevator car”, when it was placed into the elevator shaft of the tower.

(It should be noted, from watching movies like “Victory At Sea”, for example, that the power of water waves, to move huge ships up and down, is truly enormous.)

The elevator shaft (and, thus, the ship placed inside it) might be square (as depicted in FIG. 5) or some other shape, as desired.

The ship (acting rather like an elevator car) would be connected to each of the four inside walls of the elevator shaft, with corrosion-resistant wheels that interlock with (and run along) corrosion-resistant wheel-channels, up and down each of the four inside walls of the elevator shaft (or, otherwise, according to how a person of ordinary skill in the elevator-construction and related prior arts might deem most appropriate) so that the ship (again, acting rather like an elevator car) would rise up and down the elevator shaft smoothly, when a wave came along, and in a safe and stable manner.

(It should be noted here that, as per Benjamin Franklin's letter of Nov. 7, 1773 to William Brownrigg, spilling even a little oil on a body of water can have a surprisingly profound calming effect on water waves. Therefore, oil—of any kind—should not be used carelessly, if at all, with the above-referenced wheels, or any other parts of the invention—in this, or any other, of its various embodiments.)

The ship-as-elevator-car would be designed in such a way (possibly with a flat, or, nearly-flat bottom) so as to maximize the amount it could be raised and dropped by the waves, to the furthest reasonable extent possible.

Near the top of the tower, and centered directly over the middle of the elevator shaft (as shown in FIG. 5) would be one generator, of the type used in Embodiment 1, but of a much bigger size.

There would also be a beam connected to the generator, as was done in Embodiment 1, but the beam would also be of a bigger size.

The bottom of the beam would be connected to the middle of the roof, of the ship-as-elevator-car.

The collars used in Embodiment 1 would be eliminated, because the elevator shaft, in this embodiment, would render them unnecessary.

(There could, instead of the arrangement noted above, be numerous generators—four, for example, which could be placed more-or-less equidistantly from one another, with one along each of the four inside walls of the tower, if so desired. In that case, the bottom of each of the beams would be connected along that side of the roof, of the ship-as-elevator-car, which was closest to it, and would be more-or-less equidistant from the other beams.)

When a wave came, the upward force of the wave would drive the ship-as-elevator-car up the elevator shaft, and thereby turn the generator, which would generate electricity.

When the wave subsided, the downward force of gravity (if the machine was set up properly) would drive the ship-as-elevator-car back down the elevator shaft, and thereby turn the generator again, which would generate electricity again.

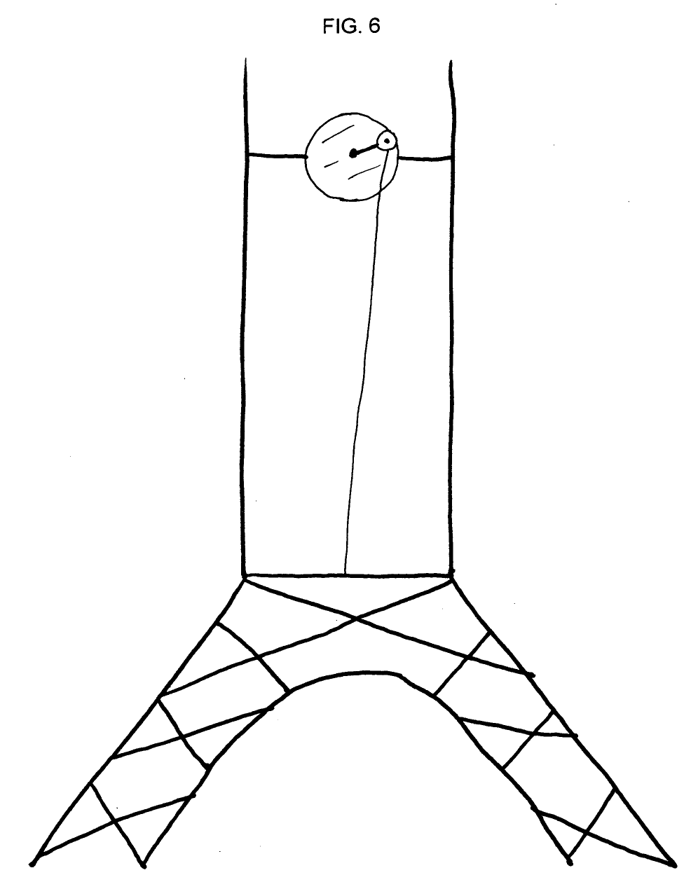

Embodiment 6 is shown in FIG. 6, and is a severe-weather version of Embodiment 2.

Embodiment 6 is the same as Embodiment 5, except as follows.

The way the top of the beam, in Embodiment 6, is attached to the generator, in Embodiment 6, is the same way it is done in Embodiment 2. In other words, Embodiment 6 is like an upside-down gasoline engine, wherein the ship-as-elevator-car (which rides up and down the elevator shaft) is like the piston, the elevator shaft is like the piston chamber, the beam is like the connecting rod, and, the way in which the upper end of the beam is connected to the generator is like the crankshaft of said upside-down gasoline engine.

The elevator shaft could be enclosed, so it is very much, indeed, like a piston chamber. Further, intake valves and outtake valves could be included on said chamber, to control the amount of water that gets into, and out of, the chamber (as is done in gasoline engines), a flywheel might be added to help moderate and regulate the speed at which the generator turns (as is done in gasoline engines, to likewise regulate the speed at which the crankshaft turns), and many of the other elements, of the prior art of gasoline engines, as well, might be added to Embodiment 6 (if desired), to make it even more remarkably similar to an upside-down gasoline engine.

Then, when a wave came, the upward thrust of the wave would raise the ship-as-elevator-car up the elevator shaft (like a piston, rising up a piston chamber), which would move the beam (acting as connecting rod), which would turn the top of the beam and the generator it's connected to (like a crankshaft), which would generate electricity.

When the downward portion of the wave came, gravity would cause the ship-as-elevator-car to fall down the elevator shaft, which would make the generator turn again, and generate electricity again.

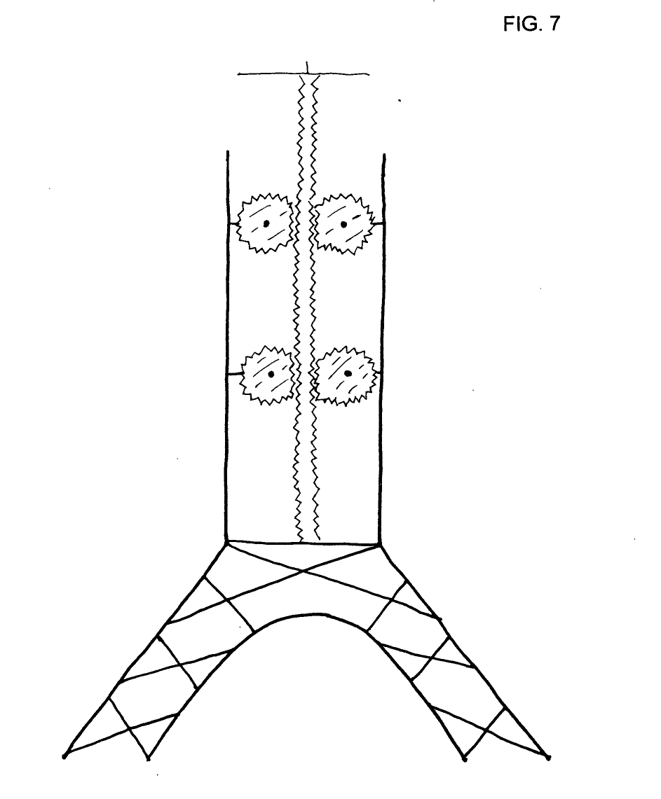

Embodiment 7 is shown in FIG. 7, and is a severe-weather version of Embodiment 3. It, too, has “industrial strength” potential, capable of generating a tremendous amount of clean, renewable electricity, if set up properly.

Embodiment 7 is the same as Embodiment 6, except as follows.

The generator in FIG. 6 has been replaced with a pair of “generator-gears” (like those specified, at considerable length, in the detailed description for Embodiment 3), and that pair of “generator-gears” is placed over the middle of the elevator shaft, near the top of the tower (as was the case with the generator in FIG. 6).

Additionally, the beam in FIG. 6 has been replaced with a beam similar to the kind used in Embodiment 3 (with teeth cut into its left and right sides) and that beam has been placed between the pair of “generator-gears”, such that the teeth of the beam meshes with the teeth of the pair of “generator-gears” (as is the case in Embodiment 3).

The bottom of the beam, in FIG. 7, has also been attached to the middle of the roof of the ship-as-elevator-car (as was done with the beam in FIG. 6).

A pair of “stability gears”, like the kind used in Embodiment 3, has also been included in FIG. 7, in the interests of thoroughness, but such “stability gears” may actually prove unnecessary (due to the stability built into the elevator shaft, itself, and the way the ship-as-elevator-car is attached to said elevator shaft, as previously addressed in the detailed description for Embodiment 5). The “stability gears” could, nonetheless, be set up as a lower pair of “generator-gears”, if so desired.

Further, the beam in FIG. 7 also has a “stopper” at its upper end (like the “stoppers” in Embodiment 3) and a “bumper” by its lower end (like the “bumpers” in Embodiment 3) for the same reasons Embodiment 3 has those two safety features (namely, to stop the beams from falling too far down, on an extreme downswing, and, to stop the ship from hitting the machine too hard, on an extreme upswing) but these features won't often, if ever, be necessary, if the machine is properly set up.

(In truth, there could actually be more than one pair of “generator-gears”, if desired. There could, for example, be one pair of “generator-gears” [with its corresponding beam, and pair of “stability gears”, or, lower pair of “generator-gears”, if desired] along each of the four inside walls of the elevator shaft, near the top of the tower, or, two such set ups, with one on the wall directly opposite the other.)

When a wave came, the rise of the wave would push the ship-as-elevator-car up the elevator shaft, and that would drive the beam upward, as well. The upward movement of the beam, then, would spin the pair of “generator-gears” it's meshed with, and that would generate electricity.

When the wave in question fell back down, the force of gravity (if the machine was set up properly) would make the ship-as-elevator-car fall back down the “elevator shaft”. That, in turn, would make the “generator-gears” spin again, which would generate electricity again.

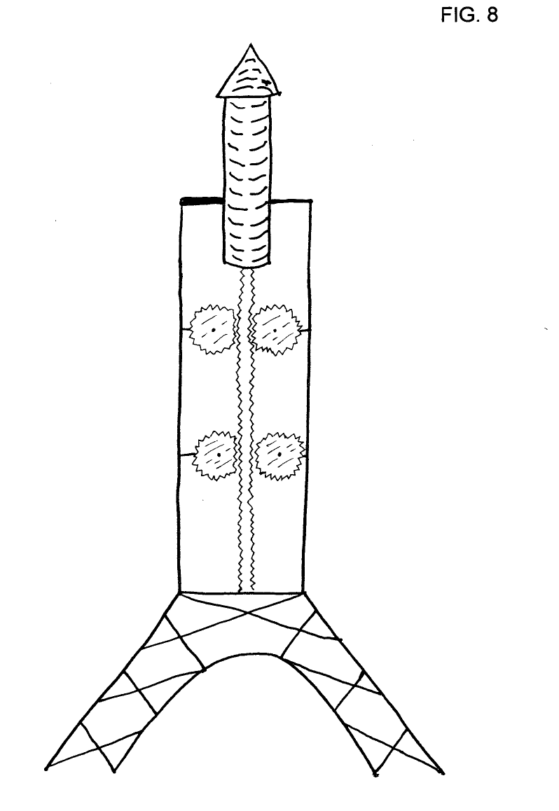

Embodiment 8 is shown in FIG. 8, and is a severe-weather version of Embodiment 4.

Embodiment 8 is the same as Embodiment 7, except as follows.

The “generator-gears” in Embodiment 7 have had their ability to generate electricity removed, such that they are simply “gears”, in Embodiment 8 (but their ability to generate electricity could actually be retained, if desired).

Instead of generating the electricity as was done in Embodiment 7, Embodiment 8 (as shown in FIG. 8) has a “sleeve”, of sorts, which is attached near the top of the tower, directly over the beam, and positioned so the beam will rise into the sleeve when a wave arises (as was the case in FIG. 4, a depiction of Embodiment 4, except that there were two such beams, and two such sleeves, in FIG. 4).

As was also the case with Embodiment 4, the sleeve in FIG. 8 would be of a large enough diameter to adequately accept its respective beam, yet of as small a diameter as reasonably possible (to maximize, or, at least, accomplish the desired effect, as set out below).

The sleeve in FIG. 8 would also be long enough to accept the furthest rise the beam might accomplish (as was the case in Embodiment 4) and be made of a weather-resistant material (perhaps somewhat like a hollow metal fencepost, as mentioned in the detailed description for Embodiment 4) according to what a person of ordinary skill in the art would deem most appropriate, and each sleeve might also have a weather-resistant cap (perhaps somewhat like a rounded, metal fencepost cap, as mentioned with Embodiment 4) according to what a person of ordinary skill in the art would deem most appropriate.

As mentioned earlier, Michael Faraday famously discovered, in 1831, that an electric current is created in a conductor (like a copper wire) if said wire is moved near a magnet, or, if said magnet is moved near the wire.

Thus, for the same reasons as those set out in the detailed description for Embodiment 4, each of the sleeves in Embodiment 8 would likewise contain magnets within them (in a configuration that a person of ordinary skill in the art would deem most suited to the application at hand) and the upper portions of each beam (which are likely to rise high enough to go into their respective sleeves) would contain copper wire (or other conductors, or be, themselves, composed of some such thing(s)—also in a configuration that a person of ordinary skill in the art would deem most suited to the application at hand).

Thus, when the beam was pushed upward by a wave, the conductor at the upper portion of the beam would be pushed into the magnetic field of its sleeve, and said motion of the conductor (at the upper portion of the beam) in the near proximity of the magnet (in the sleeve) would generate electricity.

The desired effect (to generate electricity) could also be accomplished if the positions of the conductor and the magnet were reversed, such that the magnets were at the upper end of the beam, and the conductor(s) were inside the sleeve.

Insofar as Embodiments 5 through 8 are concerned, it should be noted that there would be no need to move the towers, because a whole team of towers could be installed at the same time, and in various different locations (to be determined, perhaps, by the kind of “zoning plan” set out in the description for Embodiment 1, and established from the pre-existing knowledge of the wave patterns for the whole area in question, among other things, which entities like the U.S. Navy might already be in possession of) such that while the wave activity might be heavier at some towers, while lighter (or non-existent) at other towers, nonetheless, it would generally be sufficiently present, somewhere amidst the whole team of towers, at any given time.

Further, if the operator didn't want to transmit the electricity generated at the towers, to the shore, by means of an underwater transmission line, for whatever reason(s), then, the towers could also be used as utility poles, and used to carry the electricity they generate back to shore themselves, via electric transmission wires that could run (far above the water line) across a team of towers (like such lines run far above land, when strung across a team of utility poles).

Further still, the towers could also be used to install solar panels, and/or windmills (in addition to Wavewheels) so that solar power and/or wind power could be generated from them, as well, and thereby make them even more cost-efficient.

Given that there are now (apparently) airplane runways that can be made to float on the surface of an ocean, or lake, or other similar body of water, and, given that other devices have likewise been made to allow deep-sea oil drilling operations to float on the surface of the water, it is also possible that the towers, of the tower-based embodiments of this invention, could likewise be set on such floating platform(s), rather than extend all the way down to the floor of the ocean, or lake, or similar body of water.

A person of ordinary skill in the relevant fields could (at least to some degree) enable each of the embodiments of this invention to be monitored and adjusted remotely (from onshore, for example) by using the same prior art that allows people to monitor and adjust their online computer files, which are located at their place of business, from a wireless laptop computer at the airport.

1. The inventor, John Edward Fay, makes the independent claim that the invention, called, The Wavewheel, includes at least:
a floatation device, acting somewhat like one of the blades of a vertical waterwheel, in that it is moved by the movement of the water it is in contact with;
and, one or more beam(s), acting somewhat like the spoke(s) of such a waterwheel, with each beam connected, at its lower end, to the floatation device;
and, one or more wheel(s), each acting somewhat like the hub of such a waterwheel, and connected to a beam, at the beam's upper end (or, nearer to said upper end than the floatation device);
and, a frame, which holds the floatation device to piston-like vertical motions (within the breadth of one full, and relatively large wave cycle), and, holds the beam(s) to piston-like vertical motions (within the breadth of one full, and relatively large wave cycle) above the floatation device, and, holds the wheel(s) vertically above the floatation device (within the breadth of one full, and relatively large wave cycle) and permanently above the water level (during reasonable weather conditions);
such that the natural movement, of a large variety of water waves, will cause the floatation device to move the beam(s), which will turn the wheel(s), which will cause a conductor to move near a magnet, or, cause a magnet to move near a conductor, and thereby induce electricity, as per Michael Faraday's famous discovery of 1831;
all occurring when the invention is properly constructed, installed, monitored, and maintained.

2. The inventor also specifically claims that Embodiment 1 of the invention is a particular species of the genus set out, generically, in claim 1, that it includes all the limitations of claim 1 (and, indeed, imposes even further limitations than claim 1) and, that it, too, can generate electricity from a large variety of water waves.

3. The inventor also specifically claims that Embodiment 2 of the invention is a particular species of the genus set out, generically, in claim 1, that it includes all the limitations of claim 1 (and, indeed, imposes even further limitations than claim 1) and, that it, too, can generate electricity from a large variety of water waves.

4. The inventor also specifically claims that Embodiment 3 of the invention is a particular species of the genus set out, generically, in claim 1, that it includes all the limitations of claim 1 (and, indeed, imposes even further limitations than claim 1) and, that it, too, can generate electricity from a large variety of water waves.

5. The inventor also specifically claims that Embodiment 4 of the invention is a particular species of the genus set out, generically, in claim 1, that it includes all the limitations of claim 1 (and, indeed, imposes even further limitations than claim 1) and, that it, too, can generate electricity from a large variety of water waves.

6. The inventor also specifically claims that Embodiment 5 of the invention is a particular species of the genus set out, generically, in claim 1, that it includes all the limitations of claim 1 (and, indeed, imposes even further limitations than claim 1) and, that it, too, can generate electricity from a large variety of water waves.

7. The inventor also specifically claims that Embodiment 6 of the invention is a particular species of the genus set out, generically, in claim 1, that it includes all the limitations of claim 1 (and, indeed, imposes even further limitations than claim 1) and, that it, too, can generate electricity from a large variety of water waves.

8. The inventor also specifically claims that Embodiment 7 of the invention is a particular species of the genus set out, generically, in claim 1, that it includes all the limitations of claim 1 (and, indeed, imposes even further limitations than claim 1) and, that it, too, can generate electricity from a large variety of water waves.

9. The inventor also specifically claims that Embodiment 8 of the invention is a particular species of the genus set out, generically, in claim 1, that it includes all the limitations of claim 1 (and, indeed, imposes even further limitations than claim 1) and, that it, too, can generate electricity from a large variety of water waves.
